(19) United States
(12) Patent Application Publication
(10) Pub. No.: US 2026/0094348 A1
(43) Pub. Date: Apr. 2, 2026

(54) GAUSSIAN SPLAT CULLING FOR REPRESENTATIONS

(71) Applicant: Apple Inc., Cupertino, CA (US)

(72) Inventors: Gilles M Cadet, Agoura Hills, CA (US); Olivier Soares, Oakland, CA (US); Borja Morales Hernando, Sunnyvale, CA (US); Yan Xiao, Sunnyvale, CA (US)

(21) Appl. No.: 19/335,262

(22) Filed: Sep. 22, 2025

Related U.S. Application Data
(60) Provisional application No. 63/700,209, filed on Sep. 27, 2024.

(51) Int. Cl. G06T 15/08; G06T 15/20; G06V 40/50

(52) U.S. Cl. CPC G06T 15/08; G06T 15/20; G06V 40/50

(57) ABSTRACT

Various implementations disclosed herein include devices, systems, and methods that generate a user representation based on selecting a subset of splat parameter data. For example, a process may include obtaining user representation data of at least a portion of an object. The representation data may include splat parameter data that define characteristics for splats representing the object. The process may further include selecting a subset of the splats representing the object (e.g., culling the splats) based on a characteristic of a viewing experience. The process may further include providing a view of a representation of the at least the portion of the object based on the selected subset of the splats, where providing the view includes rendering the subset of the splats based on the splat parameter data.

### CROSS-REFERENCE TO RELATED APPLICATIONS

This Application claims the benefit of U.S. Provisional Application Ser. No. 63/700,209 filed Sep. 27, 2024, which is incorporated herein in its entirety.

### TECHNICAL FIELD

The present disclosure generally relates to electronic devices, and in particular, to systems, methods, and devices for representing objects in computer-generated content.

### BACKGROUND

Existing techniques may not accurately or honestly present current (e.g., real-time) representations of the appearances of objects, such as users of electronic devices. For example, a device may provide a representation of a user based on images of the user's face that were obtained minutes, hours, days, or even years before. Such a representation may not accurately represent the user's appearance, for example, not showing a person's hair correctly for a realistic representation. Thus, it may be desirable to provide a means of efficiently providing more accurate, honest, and/or current representations of objects, such as users (e.g., a persona).

### SUMMARY

Various implementations disclosed herein include devices, systems, and methods that generate a view of a user representation based on three-dimensional (3D) Gaussian splatting. Gaussian splatting is a technique where individual 3D points are represented as Gaussian distributions (like “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints.

In an exemplary implementation, a first set of captured user data (e.g., enrollment data) may be used to generate user representation data including splat parameter data (e.g., a 23 channel Gaussian UV map) at a first device (e.g., a sending device). The view of the user representation may be provided to a viewing device (e.g., rendering a live view of a sender's persona) by generating splats corresponding to modified user representation data. A persona is a representation of a user, like an avatar. Advantageously, splatting avoids the need to use a mesh to avoid the appearance of holes and provides other advantages. The 3D representations of the user at multiple instants in time may be generated on a viewing device that combines the data and uses the combined data to render views, for example, during a live communication (e.g., a virtual communication or a co-presence) session.

In some implementations, to improve efficiency, since not all splats are needed for each frame, the splats may be culled based on: (i) a viewer's field-of-view (FoV), (ii) a viewer's gaze, and/or (iii) splats occluded based on the viewer's viewpoint. Improving the efficiency of rendering via Gaussian splatting, these rendering techniques may address challenges associated with generating live user representations at a head mounted device (HMD) (e.g., high refresh rate, high resolution, stereo display, etc.).

In some implementations, data associated with each splat of a user representation may represent a texture/color, a 3D position, direction and angle information (e.g., cone of visibility), a splat shape, a level of transparency, a covariance (e.g., how a splat is stretched/scaled), and the like. The splats may be a 3D Gaussian distribution in a two-dimensional (2D) space with color/density (e.g., parameterization), where a person's face may be utilized as a grid, and a number of splats may be determined based on a ray off the face/grid. The grid/parameterization of the splat distribution provides higher quality data, may be faster to train a machine learning model, and may provide faster (e.g., real-time) rasterization. In some implementations, 3D mapping information (e.g., identifying x, y, z positions corresponding to UV coordinates of a UV map) may be generated at enrollment (e.g., Gaussian UV maps).

Several advantages may be realized using the relatively simple set of values with depth values defined relative to multiple points as expressed by 3D Gaussian splats using UV mapping. The set of values may require less computation and bandwidth than using a 3D mesh or 3D point cloud, while enabling a more accurate user representation than an RGBDA image. Moreover, the set of values may be formatted/packaged in a way that is similar to existing formats, e.g., RGBDA images, which may enable more efficient integration with systems that are based on such formats.

In general, one innovative aspect of the subject matter described in this specification can be embodied in methods that include the actions of, at a processor of a device, obtaining representation data representing at least a portion of an object, wherein the representation data includes splat parameter data that define characteristics for splats representing the object, selecting a subset of the splats representing the object based on a characteristic of a viewing experience, and providing a view of a representation of the at least the portion of the object based on the selected subset of the splats, wherein providing the view includes rendering the subset of the splats based on the splat parameter data.

These and other embodiments can each optionally include one or more of the following features.

In some aspects, the at least the portion of the object includes a face portion and an additional portion of a user. In some aspects, the representation data is based on three-dimensional (3D) point cloud points associated with distribution data defining sizes and shapes for rendering the 3D point cloud points as splats.

In some aspects, the splat parameter data includes 3D Gaussian parameters. In some aspects, the 3D Gaussian parameters includes at least one of position information, direction and angle information, color information, covariance information, transparency information, an orientation, opacity information, extent information in each axis, rotation data, a scale, and semantic information.

In some aspects, the characteristic of the viewing experience includes a field-of-view (FoV) and selecting the subset of the splats is based on the FoV associated with a viewpoint of the view of the representation.

In some aspects, the characteristic of the viewing experience includes a field-of-view (FoV) and selecting the subset of the splats is based on the pupillary response corresponding to a viewpoint of the view of the representation.

In some aspects, the characteristic of the viewing experience includes a viewpoint of the view of the representation and selecting the subset of the splats is based on identifying one or more splats that are occluded by an adjacent splat associated with the viewpoint.

In some aspects, the characteristic of the viewing experience includes a viewing direction and selecting the subset of the splats is based on determining whether a visibility direction and angle of one or more splats approximately aligns the viewing direction.

In some aspects, the characteristic of the viewing experience includes a viewpoint of the view of the representation and selecting the subset of the splats is based on at least one of a field-of-view (FoV) associated with the viewpoint, a pupillary response corresponding to the viewpoint, identifying one or more splats that are occluded by an adjacent splat associated with the viewpoint, and determining whether a visibility direction and angle of one or more splats approximately aligns with a viewing direction of the viewpoint.

In some aspects, the view of the representation is provided for a first frame of a plurality of frames for a first viewpoint, and the method further includes the actions of, for a second viewpoint for a second frame of the plurality of frames: determining that the second viewpoint is equivalent to the first viewpoint, and reusing the view of the representation of the at least the portion of the object from the first frame for the second frame.

In some aspects, the view of the representation is provided for a first frame of a plurality of frames for a first viewpoint, the method further includes the actions of, for a second viewpoint for a second frame of the plurality of frames: determining that the second viewpoint is different than the first viewpoint, selecting an additional subset of the splats based on a characteristic of a viewing experience associated with the second frame, and updating the view of the representation of the at least the portion of the object based on the selected additional subset of splats.

In some aspects, the representation data is generated and updated during an enrollment process based on images of a face of a user captured while the user is expressing a plurality of different facial expressions. In some aspects, a technique generates the representation data via a machine learning model trained using training data obtained via one or more sensors in one or more environments.

In some aspects, providing the view of the representation of the at least the portion of the object based on the selected subset of splats includes displaying the representation in an extended reality (XR) environment. In some aspects, the representation data is obtained in a first physical environment, and the representation is displayed in a view of a second physical environment that is different than the first physical environment. In some aspects, the representation of the at least the portion of the object is a 3D representation.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device obtaining sensor data from a user according to some implementations.

FIG. 2 illustrates exemplary electronic devices operating in different physical environments during a communication session of a first user at a first device and a second user at a second device with a view of a combined three-dimensional (3D) representation of the second user for the first device in accordance with some implementations.

FIG. 3A-3D illustrate examples of 3D Gaussian splats for use with generating views of 3D representations in accordance with some implementations.

FIG. 4 illustrates an example of culling Gaussian splats in accordance with some implementations.

FIG. 5 illustrates an example of generating and displaying a stereo view of splats on a device in accordance with some implementations.

FIG. 6 illustrates an example of generating a representation of a user based on rendering splat parameter data using a selected subset of splats in accordance with some implementations.

FIG. 7 is a flowchart representation of a method for providing a view of a user representation based on rendering splat parameter data using a selected subset of splats in accordance with some implementations.

FIG. 8 is a block diagram illustrating device components of an exemplary device according to some implementations.

FIG. 9 is a block diagram of an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

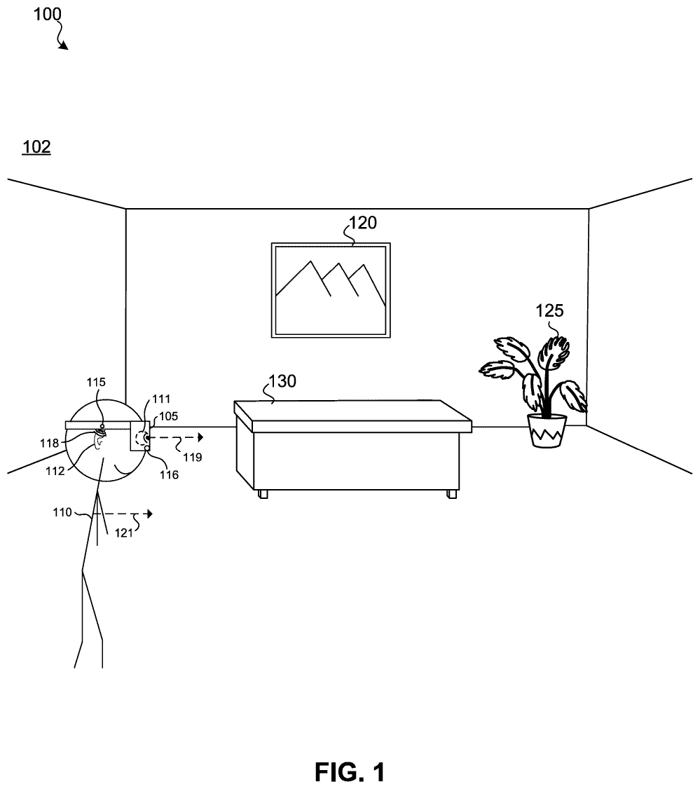

FIG. 1 illustrates an example environment 100 of exemplary electronic device 105, operating in a physical environment 102. In some implementations, electronic device 105 may be able to share information with another device or with an intermediary device, such as an information system. Additionally, physical environment 102 includes user 110 wearing device 105. In some implementations, the device 105 is configured to present views of an extended reality (XR) environment, which may be based on the physical environment 102, and/or include added content such as virtual elements.

In the example of FIG. 1, the physical environment 102 is a room that includes physical objects such as wall hanging 120, plant 125, and desk 130. The electronic device 105 may include one or more cameras, microphones, depth sensors, motion sensors, or other sensors that can be used to capture information about and evaluate the physical environment 102 and the objects within it, as well as information about user 110.

In the example of FIG. 1, the device 105 includes one or more sensors 116 that capture light-intensity images, depth sensor images, audio data or other information about the user 110 (e.g., internally facing sensors and externally facing cameras). For example, the one or more sensors 116 may capture images of the user's (e.g., user 110) forehead, eyebrows, eyes, eye lids, cheeks, nose, lips, chin, face, head, hands, wrists, arms, shoulders, torso, legs, or other body portion. For example, internally facing sensors may see what's inside of the device 105 (e.g., the user's eyes and around the eye area), and other external cameras may capture the user's face outside of the device 105 (e.g., egocentric cameras that point toward the user 110 outside of the device 105). Sensor data about a user's eye 111, as one example, may be indicative of various user characteristics, e.g., the user's gaze direction 119 over time, user saccadic behavior over time, user eye dilation behavior over time, etc. The one or more sensors 116 may capture audio information including the user's speech and other user-made sounds as well as sounds within the physical environment 100.

In some implementations, the device 105 includes an eye tracking system for detecting eye position and eye movements via eye gaze characteristic data. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 110. Moreover, the illumination source of the device 105 may emit NIR light to illuminate the eyes of the user 110 and the NIR camera may capture images of the eyes of the user 110. In some implementations, images captured by the eye tracking system may be analyzed to detect position and movements of the eyes of the user 110, or to detect other information about the eyes such as color, shape, state (e.g., wide open, squinting, etc.), pupil dilation, or pupil diameter. Moreover, the point of gaze estimated from the eye tracking images may enable gaze-based interaction with content shown on the near-eye display of the device 105.

Additionally, the one or more sensors 116 may capture images of the physical environment 100 (e.g., externally facing sensors). For example, the one or more sensors 116 may capture images of the physical environment 100 that includes physical objects such as wall hanging 120, plant 125, and desk 130. Moreover, the one or more sensors 116 may capture images (e.g., light intensity images and/or depth data).

One or more sensors, such as one or more sensors 115 on device 105, may identify user information based on proximity or contact with a portion of the user 110. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding based on sensor data obtained by a user worn device, such as first device 105. Such a user understanding may be indicative of a user state that is associated with providing user assistance. In some example, a user's appearance or behavior or an understanding of the environment may be used to recognize a need or desire for assistance so that such assistance can be made available to the user. For example, based on determining such a user state, augmentations may be provided to assist the user by enhancing or supplementing the user's abilities, e.g., providing guidance or other information about an environment to disabled/impaired person.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

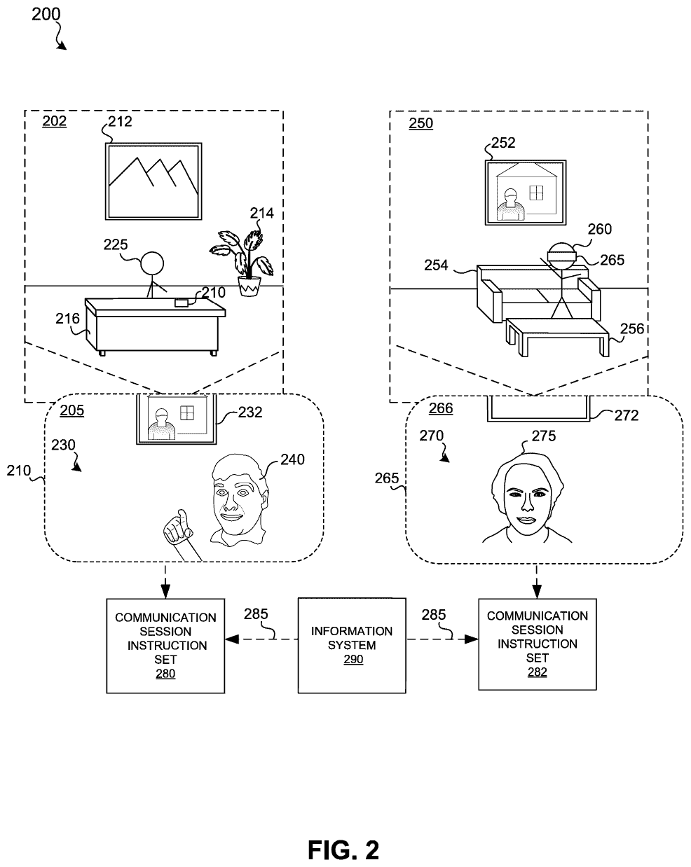

FIG. 2 illustrates exemplary electronic devices operating in different physical environments during a communication session of a first user at a first device and a second user at a second device with a view of a 3D representation of the second user for the first device in accordance with some implementations. In particular, FIG. 2 illustrates exemplary operating environment 200 of electronic devices 210, 265 operating in different physical environments 202, 250, respectively, during a communication session, e.g., while the electronic devices 210, 265 are sharing information with one another or an intermediary device such as a communication session system/server. In this example of FIG. 2, the physical environment 202 is a room that includes a wall hanging 212, a plant 214, and a desk 216 (e.g., physical environment 102 of FIG. 1). The electronic device 210 includes one or more cameras, microphones, depth sensors, or other sensors that can be used to capture information about and evaluate the physical environment 202 and the objects within it, as well as information about the user 225 of the electronic device 210 (e.g., a handheld device). The information about the physical environment 202 and/or user 225 may be used to provide visual content (e.g., for user representations) and audio content (e.g., for audible voice or text transcription) during the communication session. For example, a communication session may provide views to one or more participants (e.g., users 225, 260) of a 3D environment that is generated based on camera images and/or depth camera images of the physical environment 202, a representation of user 225.

Additionally, in this example of FIG. 2, the physical environment 250 is a room that includes a wall hanging 252, a sofa 254, and a coffee table 256. The electronic device 265 includes one or more cameras, microphones, depth sensors, or other sensors that can be used to capture information about and evaluate the physical environment 250 and the objects within it, as well as information about the user 260 of the electronic device 265 (e.g., a user worn device or HMD device, such as device 105). The information about the physical environment 250 and/or user 260 may be used to provide visual and audio content during the communication session. For example, a communication session may provide views of a 3D environment that is generated based on camera images and/or depth camera images (from electronic device 265) of the physical environment 250 as well as a representation of user 260 based on camera images and/or depth camera images (from electronic device 265) of the user 260. For example, a 3D environment may be sent by the device 210 by a communication session instruction set 280 in communication with the device 265 by a communication session instruction set 282 (e.g., via the information system 290 via network connection 285). The information system 290 may orchestrate the encryption/decryption and pre-downloading of an asset (e.g., 3D asset data, such as data associated with user representations 240, 275) between two or more devices (e.g., electronic devices 210 and 265).

FIG. 2 illustrates an example of a view 205 of a virtual environment (e.g., 3D environment 230) at device 210, where a representation 232 of the wall hanging 252 and a user representation 240 is provided (e.g., a persona of user 260), provided there is a consent to view the users'representations of each user during a particular communication session. In particular, the user representation 240 of user 260 is generated based on one or more user representation techniques for a more realistic persona generated in real time. The generation of user representations is further discussed herein.

Additionally, the electronic device 265 within physical environment 250 provides a view 266 that enables user 260 to view representation 272 of the wall hanging 212 and a representation 275 (e.g., a persona) of at least a portion of the user 225 (e.g., from mid-torso up) within the 3D environment 270. In other words, the user representation 240 of user 260 is generated at device 210 by generating combined 3D representations of the user 260 for the multiple instants in a period of time based on data obtained from device 265 (e.g., a frame-specific 3D representation of user 260). Alternatively, in some embodiments, user representation 240 of user 260 is generated at device 265 (e.g., sending device of a speaker) and sent to device 210 (e.g., viewing device to view a persona of the speaker). In some embodiments, each of the 3D representations 240 of user 260 and 275 of user 225 is generated by generating splats corresponding to modified user representation data according to techniques described herein.

In the example of FIG. 2, the electronic device 210 is illustrated as hand-held device and electronic device 265 is illustrated as a head-mounted device (HMD). However, either of the electronic devices 210 and 265 may be a mobile phone, a tablet, a laptop, so forth, or like electronic device 265, may be worn by a user (e.g., head-worn device (glasses), headphones, an ear mounted device, and so forth). In some implementations, functions of the devices 210 and 265 are accomplished via two or more devices, for example a mobile device and base station or a head mounted device and an ear mounted device. Various capabilities may be distributed amongst multiple device, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 210 and 265 may communicate with one another via wired or wireless communications. In some implementations, each device communicates with a separate controller or server to manage and coordinate an experience for the user (e.g., a communication session server). Such a controller or server may be located in or maybe remote relative to the physical environment 202 and/or physical environment 250.

Additionally, in the example of FIG. 2, the 3D environments 230 and 270 are XR environments that are based on a common coordinate system that can be shared with other users (e.g., a virtual room for personas for a multi-person communication session). In other words, the common coordinate system of the 3D environments 230 and 270 are different than the coordinate system of the physical environments 202 and 250, respectively. For example, a common reference point may be used to align the coordinate systems. In some implementations, the common reference point may be a virtual object within the 3D environment that each user can visualize within their respective views. For example, a common center piece table that the user representations (e.g., the user's personas) are positioned around within the 3D environment. Alternatively, the common reference point is not visible within each view. For example, a common coordinate system of a 3D environment may use a common reference point for positioning each respective user representation (e.g., around a table/desk). Thus, if the common reference point is visible, then each view of the device would be able to visualize the “center” of the 3D environment for perspective when viewing other user representations. The visualization of the common reference point may become more relevant with a multi-user communication session such that each user's view can add perspective to the location of each other user during the communication session.

In some implementations, the representations of each user may be realistic or unrealistic and/or may represent a current and/or prior appearance of a user. For example, a photorealistic representation of the user 225 or 260 may be generated based on a combination of live images and prior images of the user. The prior images may be used to generate portions of the representation for which live image data is not available (e.g., portions of a user's face that are not in view of a camera or sensor of the electronic device 210 or 265 or that may be obscured, for example, by a headset or otherwise). In one example, the electronic devices 210 and 265 are HMDs and live image data of the user's face includes a downward facing camera that obtains images of the user's cheeks and mouth and inward facing camera images of the user's eyes, which may be combined with prior image data of the user's other portions of the user's face, head, and torso that cannot be currently observed from the sensors of the device. Prior data regarding a user's appearance may be obtained at an earlier time during the communication session, during a prior use of the electronic device, during an enrollment process used to obtain sensor data of the user's appearance from multiple perspectives and/or conditions, or otherwise.

In some implementations, generating one or more user representations for a communication session as illustrated in FIG. 2 (e.g., generating user representation 240, 275), may be based on one more rendering techniques, such as using a 3D mesh or a 3D point cloud. However, techniques described herein utilize a 3D gaussian splat rendering approach using UV mapping. Several advantages may be realized using a simple set of values with depth values defined relative to multiple points as expressed by 3D Gaussian splats using UV mapping. The set of values may require less computation and bandwidth than using a 3D mesh or 3D point cloud, while enabling a more accurate user representation than an RGBDA image. Moreover, the set of values may be formatted/packaged in a way that is similar to existing formats, e.g., RGBDA images, which may enable more efficient integration with systems that are based on such formats.

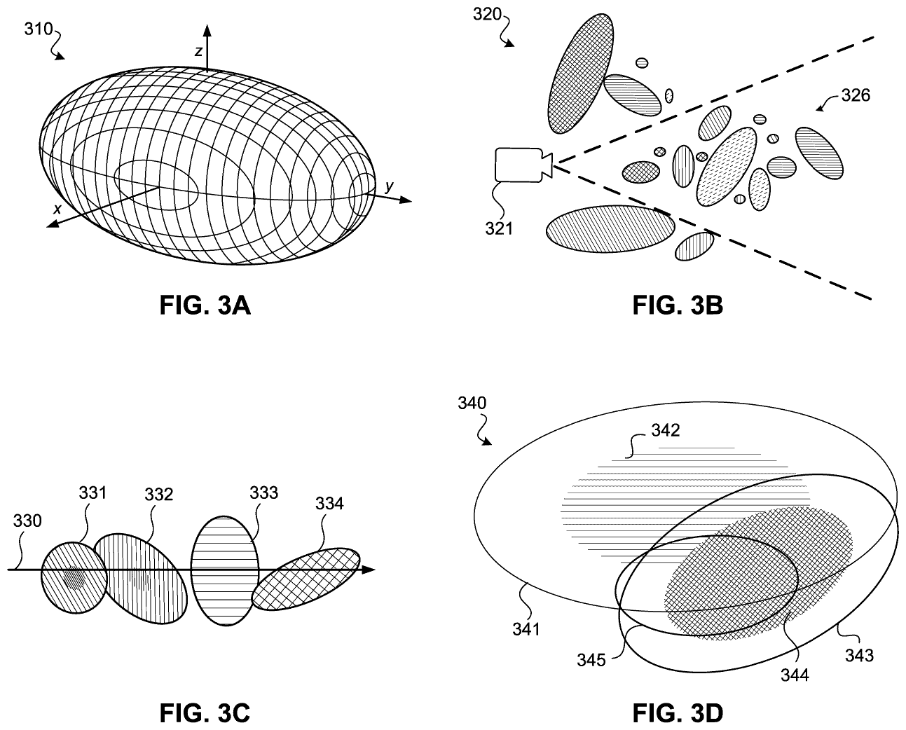

FIG. 3A-3D illustrate examples of 3D Gaussian splats for use with generating views of 3D representations in accordance with some implementations. For example, 3D Gaussian Splatting (3DGS) may be used for 3D modeling to represent complex scenes as a combination of a large number of colored 3D Gaussians which are rendered into camera views via splatting-based rasterization. The positions, sizes, rotations, colors and opacities of these Gaussian splats can then be adjusted via differentiable rendering and gradient-based optimization such that they represent the 3D scene given by a set of input images.

FIG. 3A illustrates a 3D Gaussian splat 310, e.g., an ellipsoid shape formed by a 3D gaussian distribution. The 3D Gaussian splat 310 may be used to represent a position (μ), such as xyz coordinates. The 3D Gaussian splat 310 may be used to represent direction and angle information for a cone of visibility. The 3D Gaussian splat 310 may further represent rotation and scale (e.g., [symbol] : covariance matrix), opacity (α), color (e.g., RGB values), anisotropic covariance, and spherical harmonic (SH) coefficients. FIG. 3B illustrates an environment 320 for rendering splats 326 based on a visibility direction of a camera 321. FIG. 3C illustrates ordering the splats along a camera look-at direction along a ray 330. For example, the splats 331, 332, 333, 334 are identified and ordered along the ray 330. For example, Gaussian splatting is a technique where individual 3D points are represented as Gaussian distributions (like “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints. FIG. 3D illustrates an environment 340 for blending splats 341, 342, 343, 344, 345 that may be viewed along the ray 330 direction from the camera view by composing the splats 331, 332, 333, 334 on an image plane. Some implementations may use screen-to-splats (e.g., similar to ray-casting techniques), splats-to-screen (e.g., similar to projection techniques), a combination thereof, or other techniques for composing splats.

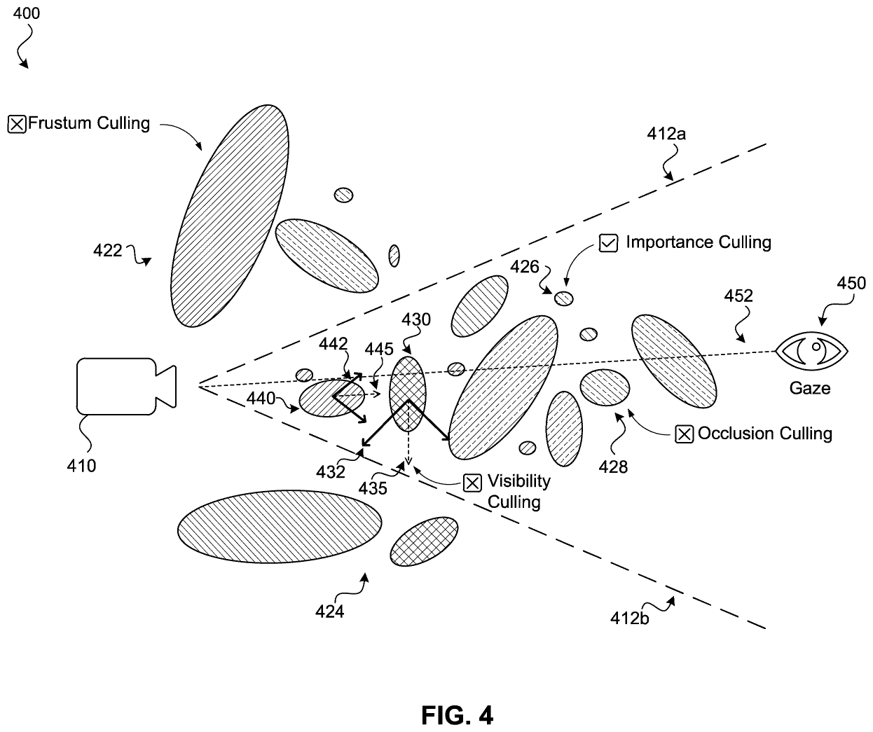

FIG. 4 illustrates an example environment 400 of culling Gaussian splats in accordance with some implementations. In particular, environment 400 illustrates selecting (e.g., culling) splats that only need to be rendered for a particular viewpoint to avoid rendering splats that a viewer would not be able to see anyway (e.g., goal of minimizing the number of splats but still provide/render an accurate representation). Splats may be culled based on a viewer's FoV, a viewer's gaze, occlusions based on the viewer's viewpoint, a level of importance, or a combination thereof. Culling may be important to improve efficiency for rendering a 3D representation as it reduces the load for sorting and blending splats.

FIG. 4 illustrates a view of a rendering of splats from a viewpoint of a camera 410 along the viewing frustrum, as illustrated by the viewpoint rays 412a, b. Additionally, environment 400 illustrates an eye gaze 450 along the ray 452 while viewing a rendering (e.g., tracking eye gaze of a viewer for each frame). As discussed herein, one or more culling techniques based on visibility (e.g., visibility culling) may be provided for culling Gaussian splats to improve efficiency for a rendering process.

In some implementations, frustrum culling may be used to identify the splats (e.g., splats in the area 422 and area 424) that lie completely outside the viewing frustum (e.g., outside the viewpoint rays 412), and remove them from a Gaussian splat rendering process. Additionally, or alternatively, in some implementations, a splat culling technique may identify and cull splats based on a viewer's gaze. For example, only render splats that are within a threshold distance of the gaze of the viewer (e.g., a threshold distance from the gaze 450 of the viewer along ray 452). Additionally, or alternatively, in some implementations, a splat culling technique may identify splats that may be considered significant or important to ensure they are rendered and identify splats that may be insignificant or unimportant to cull so that they are not rendered or rendered using a different approach than that used for the significant or important splats. Moreover, one or more splats may be identified and rendered based on priority. For example, splat 426 may be culled because it may be determined and/or deprioritized based on a size or another splat parameter.

Additionally, or alternatively, in some implementations, a splat culling technique may identify splats that are occluded based on the user's viewpoint (e.g., based on the gaze 450 of the viewer along ray 452) to cull. For example, identify the splats (e.g., splats in the area 428) that may be occluded by other splats based on the user's viewpoint (e.g., based on the gaze 450 of the viewer along ray 452), and remove those splats from a Gaussian splat rendering process. For example, a current viewpoint of a front/face of a user, there may not be a need to render the back side of the head in the current view. In particular, a splat culling technique may detect occlusions among splats, which are collectively used to render a representation, and not render splats that would not be visible to a viewer based on a current view. In other words, there is no need to utilize resources to render a splat if it will be occluded during a current view of a rendering.

Furthermore, as illustrated in FIG. 4, splat 440 includes a dominant visibility direction 445 within a cone of visibility 442, and splat 430 includes a dominant visibility direction 435 within a cone of visibility 432. In some implementations, Gaussian splat culling techniques for visibility culling may augment a splat based on a cone of visibility (e.g., a direction and an angle of a splat) that approximately matches a dominant visibility direction for the splat and use the angle between the cone direction and the view direction (camera to splat) to cull the splat. For example, Gaussian splat culling techniques for visibility culling may augment a splat based on a cone of visibility (e.g., a direction and an angle of a splat) that approximately matches a dominant visibility direction for the splat and use the angle between the cone direction and the view direction (camera to splat) to cull the splat. For example, the dominant visibility direction 445 of splat 440 may be approximately aligned with the viewing direction of the camera 410 (e.g., within an angular threshold of +/−30 degrees, or the like), and therefore may not be culled. However, the dominant visibility direction 435 of splat 430 is not aligned with the viewing direction of the camera 410 (e.g., approximately normal to the viewing direction, thus not within an angular threshold) and therefore may culled. In some implementations, a cone of visibility may be precomputed or learned (e.g., via a machine learning model technique).

Additionally, or alternatively, in some implementations, visibility caching may be used to improve efficiency for rendering by reusing a set of Gaussian splats. For example, by taking advantage of temporal coherency, the system may re-use a set of splats that contributed to the formation of an image in the past in order to minimize the number of splats used to generate a new image. For example, splats that were not visible in a short time window may then be culled for subsequent frames unless the system detects a change in a viewpoint or a viewer's pose, detects a failure during rendering (e.g., gaps or issues in rendering quality), and the like.

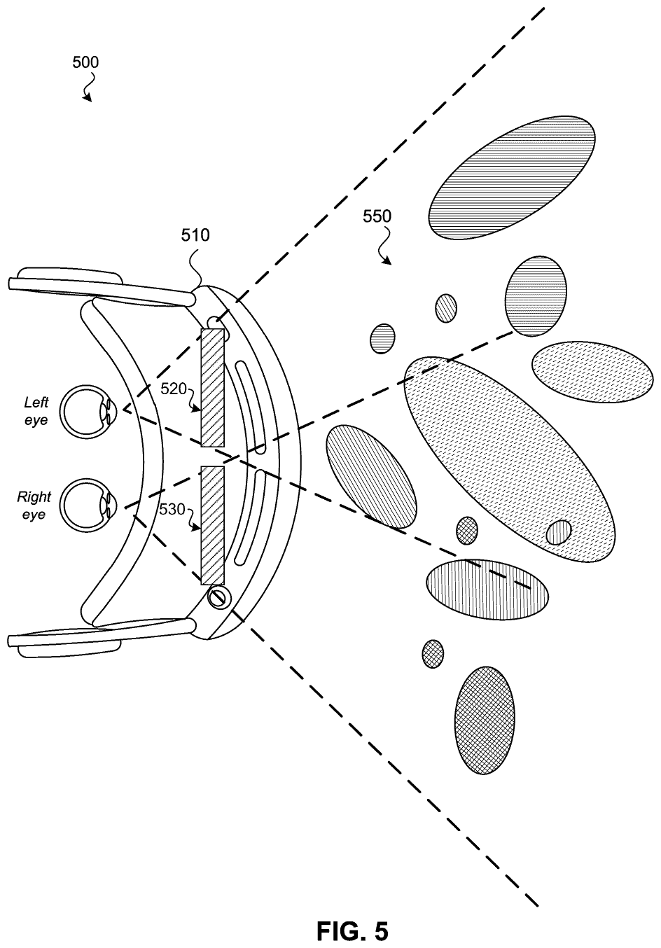

FIG. 5 illustrates an example environment 500 for generating and displaying a stereo view of splats on a device (e.g., an HMD) in accordance with some implementations. For example, the device 510 is an HMD that includes a first display 520 for a left eye view and a second display 530 for a right eye view. The first display 520 and the second display 530 may then view the rendered splats 550 for each respective viewpoint accordingly. In some implementations, the generated images for each viewpoint may be rendered as a single mono image (e.g., render for one eye), or the images may be presented as a stereo view, as illustrated in FIG. 5. Additionally, or alternatively, in some implementations, the generated images for each viewpoint may be rendered as a single grid mesh, or a combination of stereo grid meshes.

In some implementations, culling techniques for selecting a subset of the splat data for rendering a stereo view may be applied in a similar technique described herein for each eye separately, or maybe applied as culling for the overall viewer's FoV, gaze, and/or occlusions based on the viewpoint. For example, a particular splat for a left eye viewpoint may be occluded, and thus not selected to be rendered, but that same splat for a right eye viewpoint may need to be rendered to avoid any holes/gaps from the rendering for the right eye viewpoint. Alternatively, in some implementations, if only one right eye or left eye viewpoint requires that a particular splat needs to be rendered, then the system described herein will render that splat for both viewpoints to avoid any mismatches or voids for the overall stereo view of the viewer.

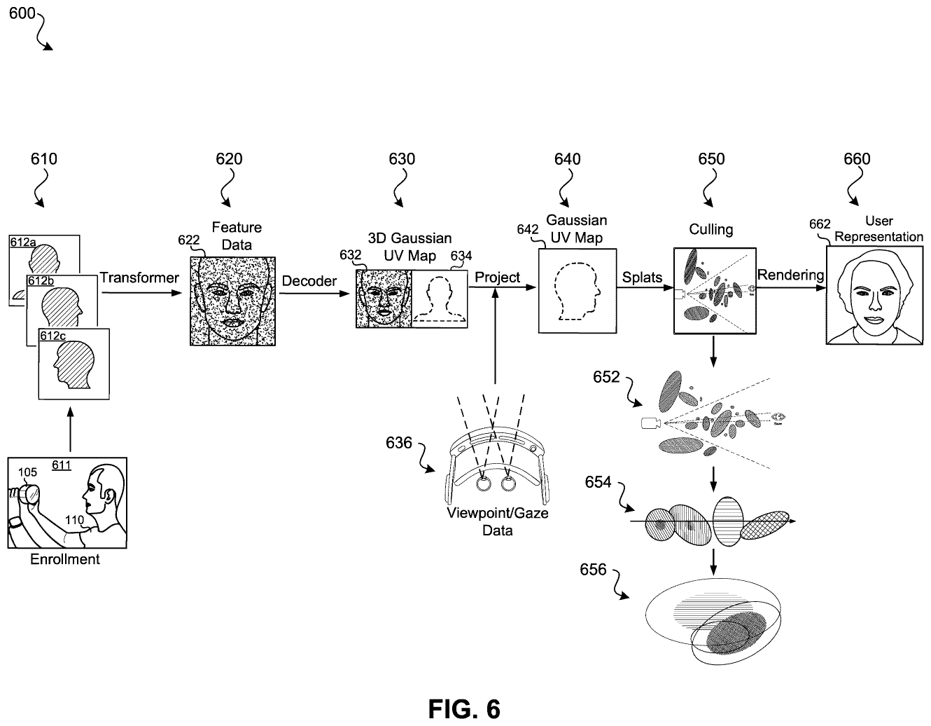

FIG. 6 illustrates an example of generating a representation of a user (e.g., a persona) based on rendering splat parameter data in accordance with some implementations. In particular, FIG. 6 illustrates an example user representation process 600 for obtaining enrollment data from an enrollment process 610 (e.g., enrollment images 612a, b, c) from a sending device for a sender and a viewpoint at a receiving device for a viewer to generate a view of a user representation 662 (e.g., a persona) using a Gaussian splatting technique.

Enrollment process 610 illustrates images of a user (e.g., user 110 of FIG. 1) during an enrollment process. An enrollment process 610 may include a user enrollment registration (e.g., preregistration of enrollment data) and obtaining sensor data (e.g., live data enrollment). The user enrollment registration, as illustrated in image 611, may include a user (e.g., user 110), obtaining a full view image of his or her face using external sensors on the device 105, and therefore, would take off and orient the device 105 (e.g., an HMD) towards his or her face during an enrollment process. The enrollment personification may be generated as the system obtains image data (e.g., RGB images) of the user's face while the user is providing different facial expressions. For example, the user may be told to “raise your eyebrows,” “smile,” “frown,” etc., in order to provide the system with a range of facial features for an enrollment process. An enrollment personification preview may be shown to the user while the user is providing the enrollment images to get a visualization of the status of the enrollment process. The enrollment image data 610 may include an enrollment personification with different user expressions and from different viewpoints (e.g., a front view in enrollment image 612a, a right side view in enrollment image 612b, and a left side view in enrollment image 612c). In some examples, more or less different expressions and/or viewpoints may be utilized to acquire sufficient data for the enrollment process.

In some implementations, a transformation of the enrollment image data to feature data 622 may occur by transforming (e.g., via a transformer) as part of a feature data process 620. For example, feature data 622 may include learned feature information of the user 110 obtained from the enrollment images, such as skin, color, and other semantic information per pixel. The feature data 622 may include a list of positions for each feature value (e.g., 14 feature channels). The feature data 622 may then be decoded by a decoder to generate a 3D Gaussian UV map for each feature as part of the Gaussian UV map process 630. The 3D points of the feature data 632 may be mapped to Gaussian parameters of the UV map 634 (e.g., 3D points +Gaussian parameters). For example, a UV map stores the x, y, z positions for the splat parameters (e.g., direction and angle information (cone of visibility information), color (view/pendent/harmonics information), covariance, alpha/transparency, orientation, opacity, extent in each axis, rotation, scale, semantic information (e.g., skin, hair, cheek, nose, lips, eyebrow, etc.). In other words, the Gaussian UV map process 630 may obtain 3D point information that includes sufficient information that which splat generation can be generated (e.g., 3D vector projections).

In some implementations, the process 600 proceeds after generating the 3D Gaussian UV Map data from the Gaussian UV map process 630 (e.g., at a sender's device after enrollment), the system (e.g., at viewer's device) may obtain the 3D Gaussian UV Map data (e.g., the feature data 632 mapped to Gaussian parameters via a UV map 634) and project the Gaussian data using a current viewpoint (e.g., viewpoint data 636) to determine a 2D Gaussian UV map 642 (e.g., 2D points+Gaussian parameters) for the Gaussian UV map process 640.

In some implementations, a subset of splats are selected during the culling process 650. For example, as described herein for FIG. 4, a culling phase 652 may identify splats that only need to be rendered for a particular viewpoint to avoid rendering splats that a viewer would not be able to see anyway. For example, splats may be culled based on a viewer's FoV, a viewer's gaze, occlusions based on the viewer's viewpoint, a level of importance, or a combination thereof. The splats may be aligned along a camera look-at direction along a ray at the alignment phase 654. Moreover, the splats may be viewed along the ray direction from the camera view by composing the splats on an image plane at the blending phase 656.

After the culling process 650 and a subset of splats are selected, then Gaussian splatting may be used for the rendering to generate a view of the user representation 662 for the user representation generation process 660. For example, a 3D Gaussian splatting technique uses the 2D points from the UV map and the associated Gaussian parameters to render an image using Gaussian splatting based on the current viewpoint of the viewer (e.g., viewpoint and gaze data 636). The rendering of a representation is illustrated as a user representation (e.g., a persona), but the Gaussian splatting and culling techniques described herein may be used for any 3D object or 3D scene reconstruction.

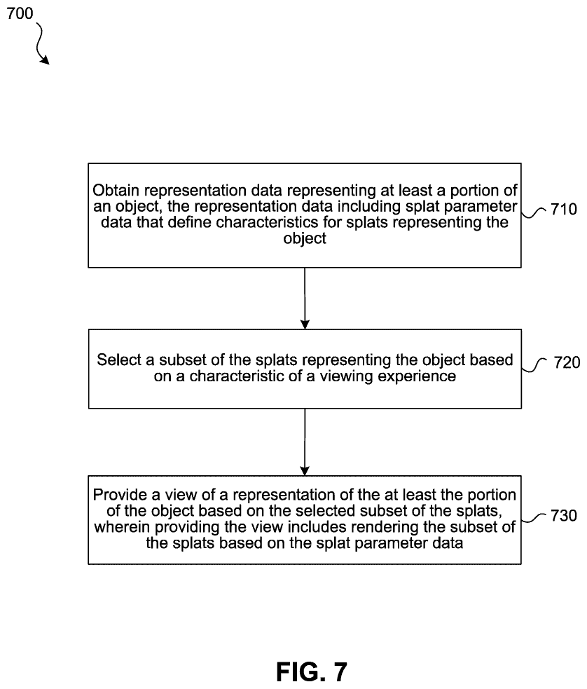

FIG. 7 is a flowchart illustrating an exemplary method 700. In some implementations, a device (e.g., device 105 of FIG. 1) performs the techniques of method 700 to generate a view of a representation of a user based on rendering splat parameter data using a selected subset of splats in accordance with some implementations. In some implementations, the techniques of method 700 are performed on a mobile device, desktop, laptop, HMD, or server device. In some implementations, the method 700 is performed on processing logic, including hardware, firmware, software, or a combination thereof. In some implementations, the method 700 is performed on a processor executing code stored in a non-transitory computer-readable medium (e.g., a memory). In some implementations, the method 700 is implemented at a processor of a device, such as a viewing device, that renders the user representation (e.g., device 210 of FIG. 2 renders 3D representation 240 of user 260 (a persona) from data obtained from device 265).

At block 710, the method 700, at a processor of a device, obtains representation datarepresenting at least a portion of an object, the representation data including splat parameter data that define characteristics for splats representing the object. For example, the representation data may be rendered using Gaussian splatting, which is a technique where individual 3D points are represented as Gaussian distributions (e.g., splat parameter data, also referred to as “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints.

In an exemplary implementation, the device is a viewing device that renders a representation of the object, such as a user representation (e.g., a persona). In some implementations, the at least the portion of the object (e.g., a person) includes a face portion and an additional portion of the user (e.g., head, neck, clothes, hair, body, etc. of a user of sending device). In other words, the method 700 is at a viewer's device that provides a view of a representation of a sender based on data from a sender's device. In an exemplary implementation, a user representation (e.g., a persona) of the sender is provided for viewing, however, the techniques described herein (e.g., Gaussian splatting culling) may render any type of object or scene for reconstruction of viewing at the viewer's device.

In some implementations, the user representation data is based on UV maps and 3D point cloud points associated with distribution data defining sizes and shapes for rendering the 3D point cloud points as splats corresponding to each point of the UV maps (e.g., 3D Gaussian map). For example, as illustrated in FIG. 5, the user representation 662 is generated for a particular viewpoint based on rendering the points from the Gaussian UV map 642 after the culling process 650.

In some implementations, the splat parameter data includes 3D Gaussian parameters. For example, the splat parameter data may include position information (e.g., a 3D position), direction and angle information (e.g., a cone of visibility), color information, covariance information, transparency information, an orientation, opacity information, extent information in each axis, rotation data, a scale, and/or semantic information (e.g., skin, hair, cheek, nose, lips, eyebrow, etc.). For example, as illustrated in FIG. 5, the Gaussian UV map process 630 generates the 3D Gaussian UV Map data 632 by transforming the enrollment image data to feature data which may include learned feature information of a user obtained from the enrollment images, such as skin, color, and other semantic information per pixel. For example, a splat parameter position may identify where a splat is located based on xyz coordinates, a splat parameter covariance may identify how a splat is stretched/scaled (e.g., a 3×3 matrix), a splat parameter color may identify an RGB color, and a splat parameter alpha (α) may identify how transparent is the splat. In some implementations, the user representation data includes 3D point cloud points associated with distribution data defining sizes and shapes for rendering 3D point cloud points as splats. For example, a splat model generated using Gaussian splats that includes texture/color, position, splat shape, and the like. In some implementations, the user representation data includes 3D mapping information that includes feature values and position information for each map point (e.g., identifying x, y, z positions corresponding to UV coordinates of a UV map).

At block 720, the method 700 selects a subset of the splats representing the object based on a characteristic of a viewing experience. In other words, the subset of splats are culled from the larger set of splats that represent the object, and the culling may be based on a viewer's FoV, a viewer's gaze, splats occluded based on the viewer's viewpoint, or a combination thereof. In some implementations, a viewing experience may be an experience in which a view of a representation of the at least the portion of the object will be rendered based on a viewpoint in a 3D environment.

In various implementations, selecting only a subset of the splats (e.g., culling splats) may improve efficiency for rendering the content because not all of the splats need to be rendered. In various implementations, the splats may be culled based on: (i) a viewer's field-of-view (FoV), (ii) a viewer's gaze, (iii) splats occluded based on the viewer's viewpoint, and/or (iv) matching approximate angles between a cone of visibility and a viewing direction. For example, in some implementations, the characteristic of the viewing experience includes a field-of-view (FoV) and selecting the subset of the splats is based on the FoV associated with a viewpoint of the view of the representation. For example, as illustrated in FIG. 4, frustrum culling may be used to identify the splats (e.g., splats in the area 422 and area 424) that lie completely outside the viewing frustum (e.g., outside the viewpoint rays 412), and remove them from a Gaussian splat rendering process.

Additionally, or alternatively, in some implementations, the characteristic of the viewing experience includes a FoV and selecting the subset of the splats is based on the pupillary response corresponding to a viewpoint of the view of the representation. For example, as illustrated in FIG. 4, culling splats based on a viewer's eye gaze 450 along the ray 452 while viewing a rendering (e.g., tracking eye gaze of a viewer for each frame).

Additionally, or alternatively, in some implementations, the characteristic of the viewing experience includes a viewing direction (e.g., visibility cone direction and an angle) and selecting the subset of the splats is based on determining whether a visibility direction and angle of one or more splats approximately aligns (matches) the viewing direction. For example, Gaussian splat culling techniques for visibility culling may augment a splat based on a cone of visibility (e.g., a direction and an angle of a splat) that approximately matches a dominant visibility direction for the splat and use the angle between the cone direction and the view direction (camera to splat) to cull the splat. For example, as illustrated in FIG. 4, a dominant visibility direction 445 of splat 440 may be approximately aligned with the viewing direction of the camera 410 (e.g., within an angular threshold of +/−30 degrees, or the like), and therefore may not be culled. However, the dominant visibility direction 435 of splat 430 is not aligned with the viewing direction of the camera 410 (e.g., approximately normal to the viewing direction, thus not within an angular threshold) and therefore may culled.

Additionally, or alternatively, in some implementations, the characteristic of the viewing experience includes a viewpoint of the view of the representation and selecting the subset of the splats is based on identifying one or more splats that are occluded by an adjacent splat associated with the viewpoint. For example, as illustrated in FIG. 4, a Gaussian splat culling technique may identify the splats (e.g., splats in the area 428) that may be occluded based on the user's viewpoint (e.g., based on the gaze 450 of the viewer along ray 452), and remove those splats from a Gaussian splat rendering process.

Additionally, or alternatively, in some implementations, the characteristic of the viewing experience includes a viewpoint of the view of the representation and selecting the subset of the splats is based on at least one of a FoV associated with the viewpoint, a pupillary response corresponding to the viewpoint, identifying one or more splats that are occluded by an adjacent splat associated with the viewpoint, and determining whether a visibility direction and angle of one or more splats approximately aligns with a viewing direction of the viewpoint. In some implementations, it may be a combination of one ore more of these culling techniques (e.g., combining these techniques and culling based on FoV, occlusion, pupillary response (gaze), and the cone of visibility.

At block 730, the method 700 provides a view of a representation of the at least the portion of the object based on the selected subset of the splats, wherein providing the view includes rendering the subset of the splats based on the splat parameter data. For example, a selected subset of splats (e.g., after culling) may be used to render a view of a user presentation (e.g., a persona), or a rendering of another object or scene. Furthermore, 3D Gaussian splatting may be used to avoid or fill holes, body pose data may be applied to include additional areas of the user (e.g., neck/shoulder area). For example, as illustrated in FIG. 6, the user representation 662 is generated for a particular viewpoint based on rendering the points from the Gaussian UV map 642 which combines the obtained splat parameters from enrollment data after the spats have been culled, and updated for each frame based on one or more marker points (e.g., a set of semantic points associated with facial features or other areas corresponding to the sender associated with the rendered user representation 662).

In various implementations, the selected subset of splats may be reused (e.g., rerendered) in subsequent frames if the characteristic (e.g., viewpoint) does not change. I some implementations, the view of the representation is provided for a first frame of a plurality of frames for a first viewpoint, the method 700 further including, for a second viewpoint for a second frame of the plurality of frames determining that the second viewpoint is equivalent to the first viewpoint, and reusing the view of the representation of the at least the portion of the object from the first frame for the second frame. Additionally, or alternatively, in some implementations, the view of the representation is provided for a first frame of a plurality of frames for a first viewpoint, the method further 700 further including, for a second viewpoint for a second frame of the plurality of frames determining that the second viewpoint is different than the first viewpoint, selecting an additional subset of the splats (i.e., culling the splats) based on a characteristic of a viewing experience associated with the second frame, and updating the view of the representation of the at least the portion of the object based on the selected additional subset of splats.

In various implementations, the method 700 further includes modifying the user representation data based on obtaining a set of sensor data obtained after an enrollment process. For example, modifying the splat parameter data based on live user data. For example, the splat parameter data may be obtained from a sending device such as from an enrollment process, and the modifications to the enrollment splat parameter data may be based on obtaining live sensor of the sender in order to determine a live representation of the sender (e.g., a live view of a realistic persona for a communication session). In some implementations, modifying the user representation data generates 3D Gaussian splats based on the image data for the at least the portion of the user, where the Gaussian splats include a texture, a position, and a splat shape. For example, a 3D Gaussian distribution in 2D space with color/density, e.g., parameterization where a face is represented as a grid, and the system determines a number or splats per ray off the face/grid. In some implementations, a technique generates a user representation via a machine learning model trained using training data obtained via one or more sensors in one or more environments. For example, a machine learning model that interprets the image data and/or other sensor data captured during enrollment.

In various implementations, the user representation data may be modified for a face and not the body, for a body and not the face, both the body and face, and/or may be modified either during an enrollment phase, on a sender side device and/or on a receiver side device. In other words, the user representation (persona) may be continuously updated to represent a live view of a current user's head/face and/or upper body movements and may be modified at different stages during a communication session. In some implementations, the user representation data is modified based on body pose data obtained during the enrollment process, during a communication session with another device, or a combination thereof. In some implementations, the device is a viewer's device, and the user representation data is modified based on an additional set of sensor data obtained during a communication session with a sender's device associated with the user representation. Alternatively, in some implementations, the user representation data is generated and updated during the enrollment process based on images of a face of the user captured while the user is expressing a plurality of different facial expressions (e.g., enrollment images of the face while the user is smiling, brows raised, cheeks puffed out, etc.).

In some implementations, the second set of sensor dataobtained after the enrollment process by the device (e.g., a viewer's device) includes a sequence of frames for a Gaussian UV Map and corresponding marker points. The sequence of frames for the Gaussian UV Map and corresponding marker points may be obtained during a communication session from a second device (e.g., a sender's device). The device (e.g., a viewer's device) renders an animated depiction of the user (e.g., a sender) based on the sequence of frames for a Gaussian UV Map and corresponding marker points using one or more splatting techniques described herein. For example, the set of Gaussian UV Map and corresponding marker points sent during a communication session with a second device may be used to render a view of the face (and upper body) of the user (sender). Additionally, or alternatively, sequential frames of face data (appearance of the user's face at different points in time) and body tracking data may be transmitted and used to display a live 3D video-like depiction of the user (e.g., a “live”persona).

In some implementations, the second user representation is based on second image data obtained via a second set of sensors in a second physical environment having a second lighting condition (e.g., different lighting condition than the first physical environment). For example, during an enrollment process, the user representation datais acquired in a particular environment (also referred to herein as an “enrollment environment”) that includes some lighting conditions information (e.g., luminance values and other lighting attributes), which may be different lighting data than live lighting data (e.g., two different physical environments between enrollment and during the generation of the persona based on “live” sensor data). In some implementations, providing the view of the representation of the at least the portion of the object based on the selected subset of splats includes displaying the representation in in a 3D environment, such as an extended reality (XR) environment.

In some implementations, the method 700 further includes modifying the view of the user representation by adjusting the user representation based on at least one color attribute of a plurality of color attributes of an environment, at least one light attribute of a plurality of light attributes of the environment, or a combination thereof. For example, adjusting a color or lighting on the user representation, such as the hair, face, clothing, and the like, based on a color and/or light associated with the viewer's environment and/or with the sender's environment. In other words, the lighting and/or color of a 3D representation (e.g., persona) may be altered to match the lighting and/or color of a viewer's environment (e.g., a reddish hue of light shining in a viewer's room would be reflected on the 3D representation). Alternatively, the lighting and/or color of a 3D representation (e.g., persona) may be altered to match the lighting and/or color of a sender's environment (e.g., a greenish hue of light shining in a sender's room would be reflected on the 3D representation to a viewer, even though the enrollment data did not reflect the greenish hue of light).

In some implementations, the user representation dataof at least a portion of a user that is obtained during an enrollment process is based on images of a face of the user captured in different poses, and/or while the user is expressing a plurality of different facial expressions. For example, the images are enrollment images of the face while the user is facing toward the camera, to the left of the camera, and to the right of the camera, and/or while the user is smiling, brows raised, cheeks puffed out, etc. For example, as illustrated by enrollment process 610 of FIG. 6, enrollment images 612 of the face may be obtained while the user is smiling, brows raised, cheeks puffed out, etc. from different viewpoints. In some implementations, the first set of sensor data corresponds to only a first area of the user (e.g., parts not obstructed by the device, such as an HMD), and the second set of sensor datacorresponds to a second area including a third area different than the first area. For example, a second area may include some of the parts obstructed by an HMD when it is being worn by the user. For example, during an enrollment process, a larger portion of a user may be captured by image data (e.g., not wearing the HMD), than during a live communication session with the user wearing the HMD.

In some implementations, as illustrated in FIG. 2, the rendering occurs during a communication session in which a second device (e.g., device 265) captures sensor data (e.g., image data of user 260 and a portion of the environment 250) and provides a sequence of frame-specific 3D representations corresponding to the multiple instants in the period time based on the sensor data. For example, the second device 265 provides/transmits the sequence of frame-specific 3D representations to device 210, and device 210 generates the combined 3D representation to display a live 3D video-like face depiction (e.g., a realistic moving persona) of the user 260 (e.g., representation 240 of user 260). Alternatively, in some implementations, the second device provides the 3D representation of the user (e.g., representation 140 of user 260) during the communication session (e.g., a realistic moving persona). For example, the combined representation is determined at device 265 and sent to device 210. In some implementations, the views of the 3D representations are displayed on the device (e.g., device 210) in real-time relative to the multiple instants in the period of time. For example, the depiction of the user is displayed in real-time and based on live lighting data (e.g., a persona shown to a second user on a display of a second device of the second user).

In some implementations, the view of the user representation may include sufficient data to enable a stereo view of the user (e.g., left/right eye views) such that the face may be perceived with depth. In one implementation, a depiction of a face includes a 3D model of the face and views of the representation from a left eye position and a right eye position and are generated to provide a stereo view of the face.

In some implementations, certain parts of the face that may be of importance to conveying a realistic or honest appearance, such as the eyes and mouth, may be generated differently than other parts of the face (e.g., based on marker points). For example, parts of the face that may be of importance to conveying a realistic or honest appearance may be based on current camera data while other parts of the face may be based on previously obtained (e.g., enrollment) face data.

In some implementations, a representation of a face is generated with texture, color, and/or geometry for various face portions identifying an estimate of how confident the generation technique is that such textures, colors, and/or geometries accurately correspond to the real texture, color, and/or geometry of those face portions based on the depth values and appearance values each frame of data. In some implementations, the depiction is a 3D persona. For example, the representation is a 3D model that represents the user (e.g., user 110 of FIG. 1).

In some implementations, the first set of sensor data and/or the second set of sensor data (e.g., live data, such as video content that includes light intensity data (RGB) and depth data), is associated with a point in time, such as images from inward/down facing sensors while the user is wearing an HMD associated with a frame. In some implementations, the sensor data includes depth data (e.g., infrared, time-of-flight, etc.) and light intensity image data obtained during a scanning process.

In some implementations, obtaining the first set of sensor data during an enrollment process may include obtaining enrollment sensor data corresponding to features (e.g., texture, muscle activation, shape, depth, etc.) of a face of a user in a plurality of configurations from a device (e.g., enrollment image data 612 of FIG. 6). In some implementations, the first set of data includes unobstructed image data of the face of the user. For example, images of the face may be captured while the user is smiling, brows raised, cheeks puffed out, etc. In some implementations, enrollment data may be obtained by a user taking the device (e.g., an HMD) off and capturing images without the device occluding the face or using another device (e.g., a mobile device) without the device (e.g., HMD) occluding the face. In some implementations, the enrollment data (e.g., the first set of data) is acquired from light intensity images (e.g., RGB image(s)). The enrollment data may include textures, muscle activations, etc., for most, if not all, of the user's face. In some implementations, the enrollment data may be captured while the user is provided different instructions to acquire different poses of the user's face. For example, the user may be instructed by a user interface guide to “raise your eyebrows,” “smile,” “frown,” etc., in order to provide the system with a range of facial features for an enrollment process.

In some implementations, the method 700 may be repeated for each frame captured during each instant/frame of a live communication session or other experience. For example, for each iteration, while the user is using the device (e.g., wearing the HMD), the method 700 may involve continuously obtaining live sensor data (e.g., face tracking data, body tracking, and the like), and for each frame, updating the selected subset of splat parameter data based on updated viewing characteristics (e.g., FoV, gaze, occlusions, etc.) for that frame, and update the displayed portions of the user representation based on the updated Gaussian data. For example, for each new frame, the system can update the display of the 3D persona based on the new data.

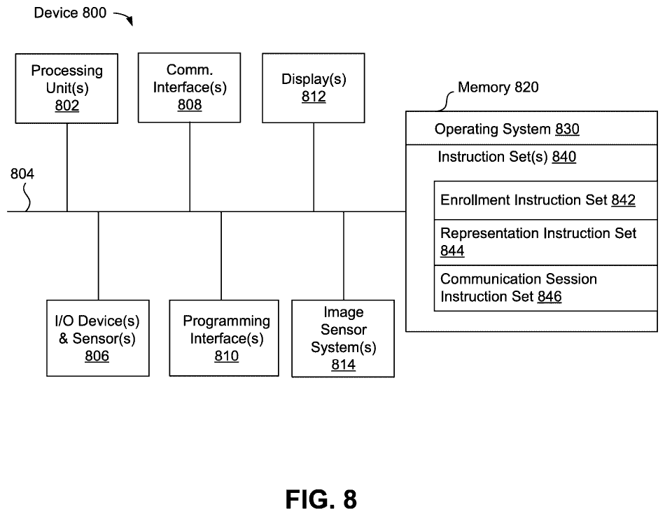

FIG. 8 is a block diagram of an example device 800. Device 800 illustrates an exemplary device configuration for devices described herein (e.g., devices 105, 210, 265, etc.). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units 802 (e.g., microprocessors, ASICs, FPGAs, GPUs, CPUs, processing cores, and/or the like), one or more input/output (I/O) devices and sensors 806, one or more communication interfaces 808 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 810, one or more displays 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 812 are configured to present a view of a physical environment or a graphical environment to the user. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 812 correspond to diffractive, reflective, polarized, holographic, etc. waveguide displays. In one example, the device 10 includes a single display. In another example, the device 10 includes a display for each eye of the user.

In some implementations, the one or more image sensor systems 814 are configured to obtain image data that corresponds to at least a portion of the physical environment 102. For example, the one or more image sensor systems 814 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of electrical charge. In some implementations, the instruction set(s) 840 are software that is executable by the one or more processing units 802 to carry out one or more of the techniques described herein.

The instruction set(s) 840 include an enrollment instruction set 842, representation instruction set 844, and a communication session instruction set 846. The instruction set(s) 840 may be embodied a single software executable or multiple software executables.

In some implementations, the enrollment instruction set 842 is executable by the processing unit(s) 802 to generate enrollment data from image data. The enrollment instruction set 842 may be configured to provide instructions to the user in order to acquire image information to generate the enrollment personification (e.g., enrollment image data 612) and determine whether additional image information is needed to generate an accurate enrollment personification to be used by the persona display process. To these ends, in various implementations, the instruction includes instructions and/or logic therefor, and heuristics and metadata therefor.

In some implementations, the representation instruction set 844 is executable by the processing unit(s) 802 to generate a representation of an object such as a user representation (e.g., rendering via a Gaussian splatting technique) by using one or more of the techniques discussed herein or as otherwise may be appropriate. In some implementations, the representation instruction set 844 is executable by the processing unit(s) 802 to analyze and select a subset of splat based on one or more culling techniques discussed herein or as otherwise may be appropriate. To these ends, in various implementations, the instruction includes instructions and/or logic therefor, and heuristics and metadata therefor.

In some implementations, the communication session instruction set 846 is executable by the processing unit(s) 802 to facilitate a communication session between two or more electronic devices (e.g., device 210 and device 265 as illustrated in FIG. 2) using one or more of the techniques discussed herein or as otherwise may be appropriate. To these ends, in various implementations, the instruction includes instructions and/or logic therefor, and heuristics and metadata therefor.

Although the instruction set(s) 840 are shown as residing on a single device, it should be understood that in other implementations, any combination of the elements may be located in separate computing devices. Moreover, FIG. 8 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

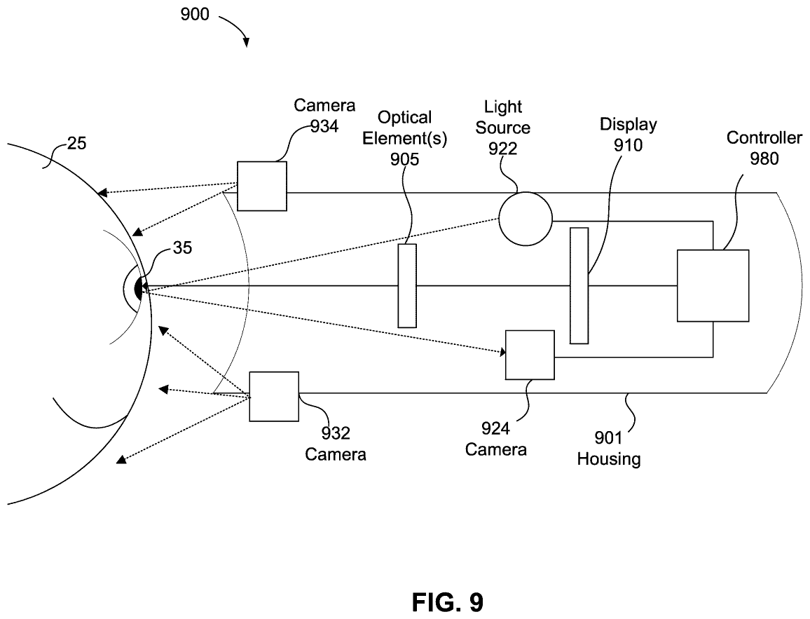

FIG. 9 illustrates a block diagram of an exemplary head-mounted device 900 in accordance with some implementations. The head-mounted device 900 includes a housing 901 (or enclosure) that houses various components of the head-mounted device 900. The housing 901 includes (or is coupled to) an eye pad (not shown) disposed at a proximal (to the user 25) end of the housing 901. In various implementations, the eye pad is a plastic or rubber piece that comfortably and snugly keeps the head-mounted device 900 in the proper position on the face of the user 25 (e.g., surrounding the eye 35 of the user 25).

The housing 901 houses a display 910 that displays an image, emitting light towards or onto the eye of a user 25. In various implementations, the display 910 emits the light through an eyepiece having one or more optical elements 905 that refracts the light emitted by the display 910, making the display appear to the user 25 to be at a virtual distance farther than the actual distance from the eye to the display 910. For example, optical element(s) 905 may include one or more lenses, a waveguide, other diffraction optical elements (DOE), and the like. For the user 25 to be able to focus on the display 910, in various implementations, the virtual distance is at least greater than a minimum focal distance of the eye (e.g., 7 cm). Further, in order to provide a better user experience, in various implementations, the virtual distance is greater than 1 meter.

The housing 901 also houses a tracking system including one or more light sources 922, camera 924, camera 932, camera 934, and a controller 980. The one or more light sources 922 emit light onto the eye of the user 25 that reflects as a light pattern (e.g., a circle of glints) that can be detected by the camera 924. Based on the light pattern, the controller 980 can determine an eye tracking characteristic of the user 25. For example, the controller 980 can determine a gaze direction and/or a blinking state (eyes open or eyes closed) of the user 25. As another example, the controller 980 can determine a pupil center, a pupil size, or a point of regard. Thus, in various implementations, the light is emitted by the one or more light sources 922, reflects off the eye of the user 25, and is detected by the camera 924. In various implementations, the light from the eye of the user 25 is reflected off a hot mirror or passed through an eyepiece before reaching the camera 924.

The display 910 emits light in a first wavelength range and the one or more light sources 922 emit light in a second wavelength range. Similarly, the camera 924 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 910 by looking at it), provide foveated rendering (e.g., present a higher resolution in an area of the display 910 the user 25 is looking at and a lower resolution elsewhere on the display 910), or correct distortions (e.g., for images to be provided on the display 910). In various implementations, the one or more light sources 922 emit light towards the eye 35 of the user 25 which reflects in the form of a plurality of glints.

In various implementations, the camera 924 is a frame/shutter-based camera that, at a particular point in time or multiple points in time at a frame rate, generates an image of the eye 35 of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 924 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 932 and camera 934 are frame/shutter-based cameras that, at a particular point in time or multiple points in time at a frame rate, can generate an image of the face of the user 25. For example, camera 932 captures images of the user's face below the eyes, and camera 934 captures images of the user's face above the eyes. The images captured by camera 932 and camera 934 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a device:
obtaining representation data representing at least a portion of an object, wherein the representation data comprises splat parameter data that define characteristics for splats representing the object;
selecting a subset of the splats representing the object based on a characteristic of a viewing experience; and
providing a view of a representation of the at least the portion of the object based on the selected subset of the splats, wherein providing the view comprises rendering the subset of the splats based on the splat parameter data.

2. The method of claim 1, wherein the at least the portion of the object comprises a face portion and an additional portion of a user.

3. The method of claim 2, wherein the representation data is based on three-dimensional (3D) point cloud points associated with distribution data defining sizes and shapes for rendering the 3D point cloud points as splats.

4. The method of claim 1, wherein the splat parameter data comprises 3D Gaussian parameters.

5. The method of claim 4, wherein the 3D Gaussian parameters comprises at least one of position information, direction and angle information, color information, covariance information, transparency information, an orientation, opacity information, extent information in each axis, rotation data, a scale, and semantic information.

6. The method of claim 1, wherein the characteristic of the viewing experience comprises a field-of-view (FoV) and selecting the subset of the splats is based on the FoV associated with a viewpoint of the view of the representation.

7. The method of claim 1, wherein the characteristic of the viewing experience comprises a field-of-view (FoV) and selecting the subset of the splats is based on a pupillary response corresponding to a viewpoint of the view of the representation.

8. The method of claim 1, wherein the characteristic of the viewing experience comprises a viewpoint of the view of the representation and selecting the subset of the splats is based on identifying one or more splats that are occluded by an adjacent splat associated with the viewpoint.

9. The method of claim 1, wherein the characteristic of the viewing experience comprises a viewing direction and selecting the subset of the splats is based on determining whether a visibility direction and angle of one or more splats approximately aligns the viewing direction.

10. The method of claim 1, wherein the characteristic of the viewing experience comprises a viewpoint of the view of the representation and selecting the subset of the splats is based on at least one of:
a field-of-view (FoV) associated with the viewpoint;
a pupillary response corresponding to the viewpoint;
identifying one or more splats that are occluded by an adjacent splat associated with the viewpoint; and
determining whether a visibility direction and angle of one or more splats approximately aligns with a viewing direction of the viewpoint.

11. The method of claim 1, wherein the view of the representation is provided for a first frame of a plurality of frames for a first viewpoint, the method further comprising, for a second viewpoint for a second frame of the plurality of frames:
determining that the second viewpoint is equivalent to the first viewpoint; and
reusing the view of the representation of the at least the portion of the object from the first frame for the second frame.

12. The method of claim 1, wherein the view of the representation is provided for a first frame of a plurality of frames for a first viewpoint, the method further comprising, for a second viewpoint for a second frame of the plurality of frames:
determining that the second viewpoint is different than the first viewpoint;
selecting an additional subset of the splats based on a characteristic of a viewing experience associated with the second frame; and
updating the view of the representation of the at least the portion of the object based on the selected additional subset of splats.

13. The method of claim 1, wherein the representation data is generated and updated during an enrollment process based on images of a face of a user captured while the user is expressing a plurality of different facial expressions.

14. The method of claim 1, wherein a technique generates the representation data via a machine learning model trained using training data obtained via one or more sensors in one or more environments.

15. The method of claim 1, wherein providing the view of the representation of the at least the portion of the object based on the selected subset of splats comprises displaying the representation in an extended reality (XR) environment.

16. The method of claim 1, wherein the representation data is obtained in a first physical environment, and the representation is displayed in a view of a second physical environment that is different than the first physical environment.

17. The method of claim 1, wherein the representation of the at least the portion of the object is a 3D representation.

18. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining representation data representing at least a portion of an object, wherein the representation data comprises splat parameter data that define characteristics for splats representing the object;
selecting a subset of the splats representing the object based on a characteristic of a viewing experience; and
providing a view of a representation of the at least the portion of the object based on the selected subset of the splats, wherein providing the view comprises rendering the subset of the splats based on the splat parameter data.

19. The device of claim 18, wherein the at least the portion of the object comprises a face portion and an additional portion of a user.

20. A non-transitory computer-readable storage medium, storing program instructions executable on a device to perform operations comprising:
obtaining representation data representing at least a portion of an object, wherein the representation data comprises splat parameter data that define characteristics for splats representing the object;
selecting a subset of the splats representing the object based on a characteristic of a viewing experience; and
providing a view of a representation of the at least the portion of the object based on the selected subset of the splats, wherein providing the view comprises rendering the subset of the splats based on the splat parameter data.
